(19) United States
(12) Patent Application Publication
(10) Pub. No.: US 2012/0134281 A1
(43) Pub. Date: May 31, 2012

(54) Monitoring And Apparatus For Pre-Configuring Conditions For Data Transfer

(76) Inventors: Aydin Osman, Stuttgart (DE); Danish Aziz, Stuttgart (DE); Michael Wilhelm, Tamm (DE); André Fonseca dos Santos, Stuttgart (DE)

(21) Appl. No.: 12/955,584

(22) Filed: Nov. 29, 2010

(51) Int. Cl. H04W 24/00

(52) U.S. Cl. 370/252

(57) ABSTRACT

A method for pre-configuring conditions of data transfer at a base station for user equipment includes receiving a data transfer request from user equipment. The data transfer request includes conditions. The base station compares the conditions with current base station performance conditions. If the comparison is favorable, the base station sends an accept message to the user equipment.

### FIELD OF THE INVENTION

The present invention relates generally to communication systems, and more particularly to wireless communication systems.

### BACKGROUND OF THE INVENTION

Wireless data growth requires efficient management of radio resources, energy consumption and interference. Improvements in Quality of Service (QoS) and user experience will also be required. Applications like Network Gaming and High Definition/3D videos put a very high demand on delay requirements of the wireless network. Hence innovative solutions are needed to handle the flow and demand of huge data through a wireless network.

Current wireless systems utilize channel quality based resource management algorithms or flat architecture-based wireless core networks, which do not provide sufficient capability to manage the QoS and user experience required to handle the huge data throughput in wireless networks.

Therefore, a need exists for an application, processor, and communication system that provide enhanced processing of wireless data while efficiently managing radio resources, energy consumption and interference.

### BRIEF SUMMARY OF THE INVENTION

User applications such as high definition videos, high definition images, and machine-to-machine (M2M) data generate significant amount of data. An exemplary embodiment of the present invention manages this data by bringing user personalization to base stations, also referred to as Node B or eNB. Hereinafter the term “eNB” is used to refer to a Base Station.

An exemplary embodiment of the present invention provides new methods that actively account for user interaction and user behavior to manage radio/core network resources, to reduce delays, to save energy consumption, and to improve QoS and user experience. This is accomplished via an application enabled eNB, which can comprise an application enabled interface in an eNB.

Current base stations typically act as the radio access point in a wireless network. In order to reduce the amount of data flow through the transport/core network and also to efficiently manage the radio resources and energy consumption, an Intelligent Radio (iRadio) Interface is provided. The radio interface, such as the eNB in LTE, can predict/estimate/schedule the user behavior with the help of user interaction directly between the user and the iRadio. In accordance with this exemplary embodiment, the eNB may host complete applications or application interfaces.

A user profile preferably resides in the most likely appearing eNB. In the situation where a mobile unit is roaming, the user profile can be forwarded from the source eNB to the target eNB. In an alternate exemplary embodiment, the profile is stored outside the eNB, such as in a separate network element.

The users can preferably configure or personalize their eNBs. In an alternate exemplary embodiment, the eNB acquires the user profile from the user equipment automatically upon building up the radio connection. Once the eNB has sufficient information about user-specific behavior, the eNB can act accordingly and manage its radio resources. The eNB can also manage interference, reduce transport/core network load, reduce delay, and reduce energy consumption. For example, the eNB can forecast traffic statistics and derive appropriate system control parameters.

In an alternate exemplary embodiment, users determine their QoS level and or application/service specific QoS and quality of experience level by configuring and personalizing their priorities for different applications and services, which is the trend in today's internet, applications and devices, such as Google, Facebook, iPhone, etc. The user will also be able to exert some control over the network and their services on the network.

The present invention allows personalization coming towards an eNB with control of the operator and introduction of application enablement in the eNB and user equipment supporting interference control, energy saving, intelligent network load distribution, and new user billing opportunities.

The present invention allows the eNB to plan and predict future resource consumption and to optimize its algorithms with this information. An exemplary embodiment provides interaction to mobile users and their current needs and satisfaction and promotes new business models in dependency of used resources at specific times, for example reduced interference level. An exemplary embodiment also provides for the management of the core radio network load and interference actively.

An exemplary embodiment of the present invention is utilized in an eNB (LTE) network.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flow diagram of a method in accordance with an exemplary embodiment of the present invention.

FIG. 3 depicts a flowchart of a method in accordance with an exemplary embodiment of the present invention.

### DETAILED DESCRIPTION OF THE INVENTION

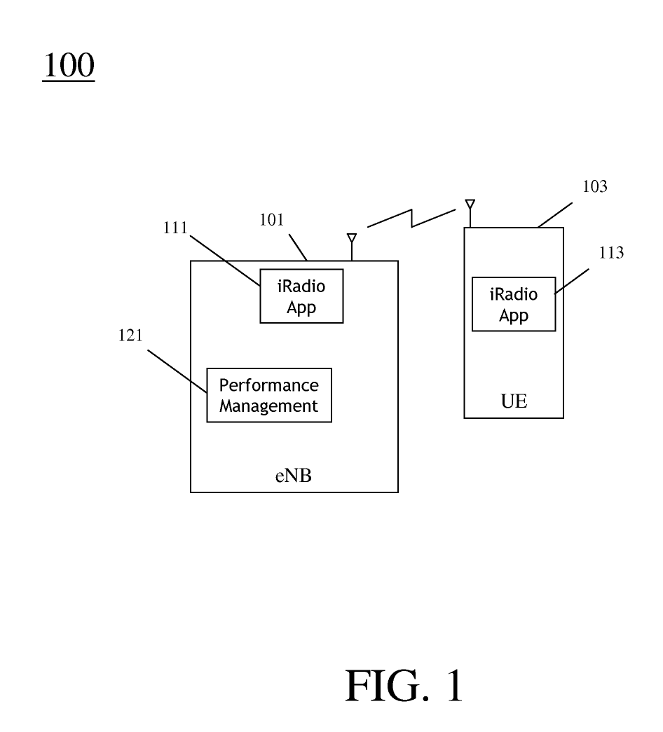

An exemplary embodiment of the present invention can be better understood with reference to FIGS. 1 through 3. FIG. 1 depicts a portion 100 of a communication system in accordance with an exemplary embodiment of the present invention. Portion 100 includes an eNB 101 and user equipment 103. It should be understood that a wireless system would include additional elements, such as mobile switching centers and the like, and would also include a plurality of base stations and mobile units. FIG. 1 only shows one base station and one user equipment for clarity and simplicity. eNB 101 preferably includes a performance management processor 121. The performance management processor 121 preferably includes processors for optimizing interference, load, energy levels and scheduling decisions.

In accordance with an exemplary embodiment, an iRadio application 111 is located in eNB 101. The end-to-end communication between user equipment 103 and eNB 101 is preferably done directly via iRadio application 111. An exemplary embodiment allows eNB 101 to plan, estimate, and predict the future resource demands and manage the interference, energy, delay, and QoS by utilizing this information. The interaction and personalization provided by this exemplary embodiment assists eNB 101 and also helps the complete network. In one embodiment, eNB 101 shares this information to the wireless network when required and the wireless network makes use of this information. This embodiment is preferably used when the resources are known and managed at eNB 101.

In an alternate exemplary embodiment, the interface is defined as a “network protocol” where the decisions are preferably based on the user's inputs. The reaction to the interface with UE 101 can therefore be done in any element in the wireless network. In this exemplary embodiment, the network protocol details may not be known to eNB 101. The iRadio application can therefore be implemented where no direct access to an eNB is possible, which is eNB transparent.

A further exemplary embodiment provides applications or application interfaces in User Equipment 103 that allows a user to interact actively, with intelligence, with eNB 101 and therefore the wireless network.

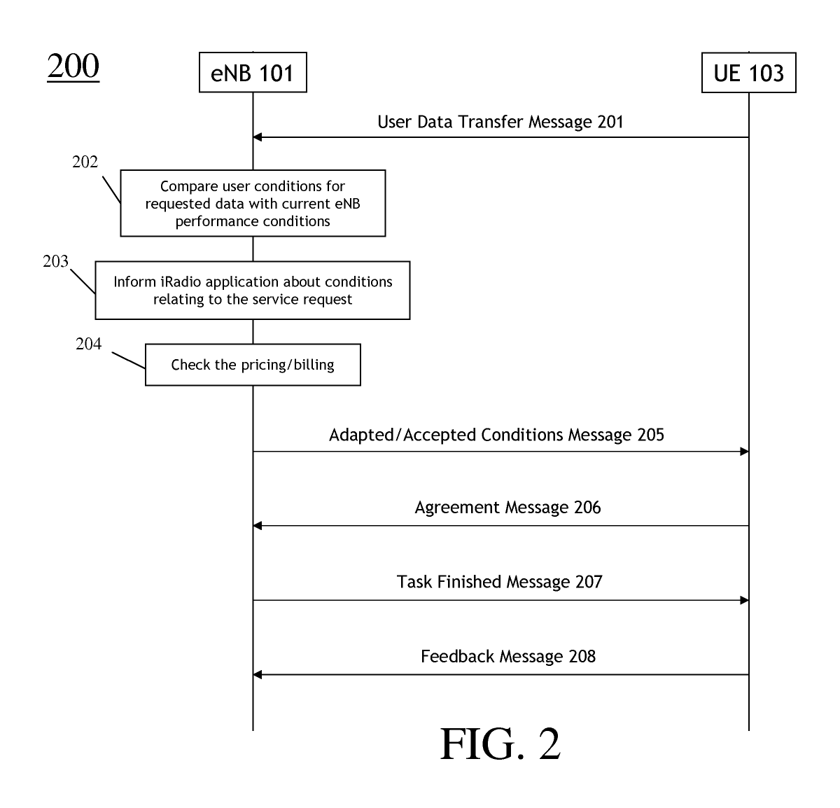

FIG. 2 depicts a flow diagram of a method in accordance with an exemplary embodiment of the present invention.

In an exemplary embodiment, a user of user equipment 103 pre-configures the conditions of data transfer of the iRadio Application 113 in mobile equipment 103. In an exemplary embodiment, this configuration can be per service type. In an alternate exemplary embodiment, the configuration can relate to transfer time, such as the transfer start time or the last ending time. These times can be obtained via, e.g., a calendar application in the user equipment. Alternately, the configuration can be related to a price, such as a maximum accepted cost for service.

User equipment 103 requests via user data transfer message 201 a service or traffic type. The user accepted conditions or data transfer types can be configured on triggering special service/traffic type by the user. Alternately, the user accepted conditions or data transfer types can be pre-configured. In an exemplary embodiment, the user accepted condition for this data transfer is time. In an alternate exemplary embodiment, the user accepted condition for this data transfer is price.

iRadio application 111 in eNB 101 compares (202) user conditions for the requested data with current eNB performance conditions, which are preferably in performance management processor 121. For example, eNB 101 compares the required size of data or the type of traffic. One example is the Quality of Service (QoS).

Performance management processor 121 informs (203) iRadio application 111 about conditions relating to the service request. In an exemplary embodiment, performance management processor 121 includes information relating to interference, load and energy consumption.

iRadio application 111 checks (204) the pricing/billing. In an exemplary embodiment, this check is for the pricing/billing for eNB 101.

eNB 101 then sends Adapted/Accepted Conditions Message 205 to user equipment 103, preferably via iRadio application 111.

UE 103 preferably accepts the conditions sent from eNB 101. In an exemplary embodiment, since UE 103 generated the request, UE 103 automatically accepts the conditions, without further input from a user of UE 103. In an alternate exemplary embodiment, UE 103 manually accepts or rejects the conditions sent from eNB 101. In a further exemplary embodiment, the conditions may not meet those sent in the original request. In this embodiment the new conditions are presented to user equipment 103 and a user of user equipment 103 can either accept or reject the new conditions sent from eNB 101.

If user equipment 103 accepts the conditions sent from eNB 101, user equipment 103 sends an Agreement Message 206 to eNB 101. If user equipment 103 does not accept the conditions sent from eNB 101, the process ends without data transfer.

eNB 101 sends a task finished message 207 to user equipment 103.

In an exemplary embodiment, user equipment 103 sends feedback message 208 to iRadio application 111 on eNB 101. The feedback in feedback message 208 preferably relates to satisfaction regarding the conditions of requested data transfer, such as the download time, pricing, or other conditions.

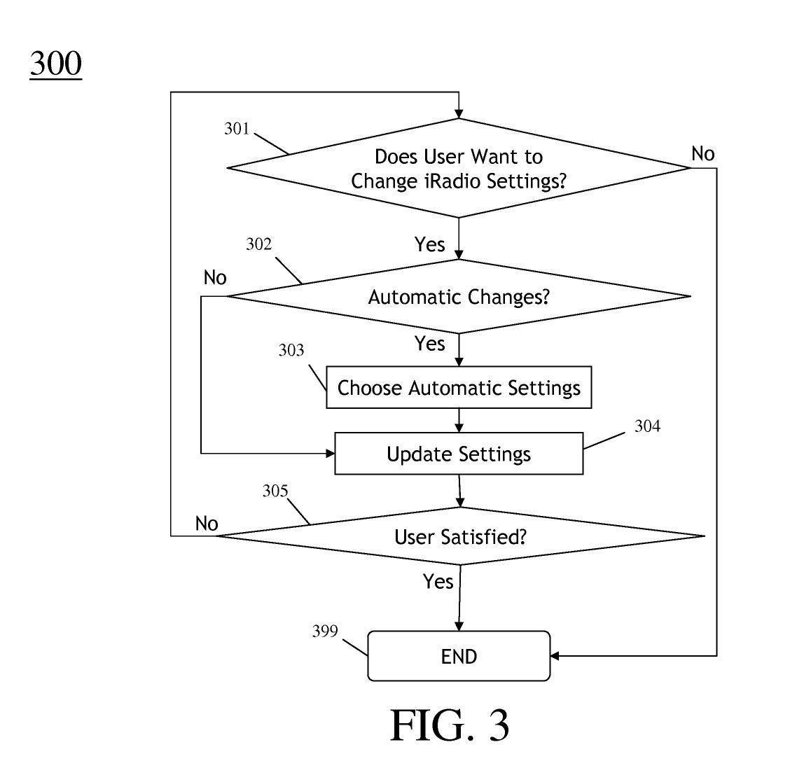

FIG. 3 depicts a flowchart 300 of a method in user equipment in accordance with an exemplary embodiment of the present invention.

A user of user equipment 103 determines (301) if he wants to change iRadio settings. If not, the process ends (399).

If the user does want to change iRadio settings, the user decides (302) if he wants to automatically change the iRadio settings. If so, the user changes (303) the automatic settings and preferably agrees to accept automatic changes and is wiling to pay a higher rate for improved services.

If the user either did not want to automatically change settings or completed the step of making the automatic, changes, the settings are updated (304).

After updating any settings, the user equipment determines (305) if the user is satisfied with the current settings. If the user is satisfied, the process ends (399). If the user is not satisfied, the process returns to step 301 and goes through the process of updating the user settings again.

An exemplary embodiment of the present invention thereby provides user involvement resulting in user behavior forecast. A user knows himself better than anyone else how fast and when he wants the information requested, and decides what cost he is willing to pay. The user can thereby manage interference appearance and energy saving.

An exemplary embodiment of provides an improved user experience and the creation of new billing rates. For example, the minimum rate can be a flat rate with less rate capability, or an increased data rate with additional charges.

The present invention also provides load distribution with no peak data loading and an enhanced mechanism for load distribution.

While this invention has been described in terms of certain examples thereof, it is not intended that it be limited to the above description, but rather only to the extent set forth in the claims that follow.

We claim:

1. A method for pre-configuring conditions of data transfer at a base station for user equipment, the method comprising:
receiving a data transfer request from user equipment, the data transfer request including conditions;
comparing the conditions with current base station performance conditions; and
if the comparison is favorable, sending an accept message to the user equipment.

2. A method for pre-configuring conditions of data transfer in accordance with claim 1, wherein the conditions relate to transfer time.

3. A method for pre-configuring conditions of data transfer in accordance with claim 1, wherein the conditions relate to price.

4. A method for pre-configuring conditions of data transfer in accordance with claim 1, wherein the data transfer request comprises a service type.

5. A method for pre-configuring conditions of data transfer in accordance with claim 1, wherein the data transfer request comprises a traffic type.

6. A method for pre-configuring conditions of data transfer in accordance with claim 1, wherein the step of comparing the conditions comprises comparing the conditions in a performance management processor located within the base station.

7. A method for pre-configuring conditions of data transfer in accordance with claim 6, wherein the step of comparing conditions in a performance management processor comprises comparing conditions in a performance management processor utilizing information relating to interference.

8. A method for pre-configuring conditions of data transfer in accordance with claim 6, wherein the step of comparing conditions in a performance management processor comprises comparing conditions in a performance management processor utilizing information relating to load.

9. A method for pre-configuring conditions of data transfer in accordance with claim 6, wherein the step of comparing conditions in a performance management processor comprises comparing conditions in a performance management processor utilizing information relating to energy consumption.

10. A method for pre-configuring conditions of data transfer in accordance with claim 1, wherein the step of comparing the conditions comprises comparing the conditions in a performance management processor located in a network element that is distinct from the base station.

11. A method for pre-configuring conditions of data transfer in accordance with claim 1, wherein the step of comparing conditions comprises comparing the required size of data.

12. A method for pre-configuring conditions of data transfer in accordance with claim 1, wherein the step of comparing conditions comprises comparing the type of traffic.

13. A method for pre-configuring conditions of data transfer in accordance with claim 1, wherein the step of comparing conditions comprises comparing the Quality of Service (QoS).

14. A method for pre-configuring conditions of data transfer in user equipment, the method comprising:
sending a data transfer request to a base station, the data transfer request including conditions;
receiving an accept message from the base station, the accept message including acceptance conditions; and
accepting the acceptance conditions.

15. A method for pre-configuring conditions of data transfer in user equipment in accordance with claim 14, wherein the step of accepting the acceptance conditions comprises automatically accepting the acceptance conditions.

16. A method for pre-configuring conditions of data transfer in user equipment in accordance with claim 14, wherein the step of accepting the acceptance conditions comprises manually accepting the acceptance conditions.

17. A method for pre-configuring conditions of data transfer in user equipment in accordance with claim 14, wherein the acceptance conditions do not equal the conditions.
